(19) United States
(12) Patent Application Publication
(10) Pub. No.: US 2018/0057339 A1
(43) Pub. Date: Mar. 1, 2018

(54) Mixed drink producing apparatus with an inline mixer, household refrigeration apparatus as well as method for producing a drink

(71) Applicant: BSH HAUSGERAETE GMBH, MUENCHEN (DE)

(72) Inventors: KUDRET BAYSAL, GIENGEN BRENZ (DE); DELIA HAHN, HEIDENHEIM AN DER BRENZ (DE); CARSTEN WEISS, GIENGEN (DE)

(21) Appl. No.: 15/252,574

(22) Filed: Aug. 31, 2016

(51) Int. Cl. B67D 1/00; F25D 23/12

(52) U.S. Cl. CPC B67D 1/0059; B67D 1/0078; F25D 23/12; B67D 1/0021

(57) ABSTRACT

A mixed drink producing apparatus as well as to a household refrigeration apparatus with a mixed drink producing apparatus with a dispensing container, which is formed for receiving a liquid addable to a cooled mixed drink by the mixed drink producing apparatus and which is connected to a dispensing unit of the mixed drink producing apparatus for conducting the liquid from the dispensing container to the dispensing unit, wherein the mixed drink producing apparatus has a gas adding unit for adding carbonizing gas to the first liquid, and the mixed drink producing apparatus has at least one inline mixer, by which the carbonizing gas added to the liquid can be disintegrated. There is also described a method for producing a mixed drink.

### TECHNICAL FIELD

The invention relates to a mixed drink producing apparatus as well as to a household refrigeration apparatus with a mixed drink producing apparatus, which is formed with at least one dispensing container, which is formed for receiving a liquid addable to a mixed drink by the mixed drink producing apparatus and which is connected to a dispensing unit of the mixed drink producing apparatus for conducting this liquid from the dispensing container to the dispensing unit. Furthermore, the invention relates to a method for producing a mixed drink in the household refrigeration apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which is formed as a drink apparatus for dispensing a drink at this household refrigeration apparatus itself.

Moreover, it is known that in apparatuses for producing and dispensing drinks, carbonization of this liquid is also allowed. In order to be able to achieve and maintain a corresponding degree of carbonization, it is provided in known apparatuses to provide them in specific tanks in carbonized manner. Therefore, additional storage tanks are required in these configurations, which moreover also allow only very inaccurate adjustments of the degree of carbonization.

### BRIEF SUMMARY OF THE INVENTION

It is the object of the present invention to provide a mixed drink producing apparatus as well as a household refrigeration apparatus as well as a method for producing a mixed drink, by which or in which the adjustment of the degree of carbonization is simply and securely allowed and a space saving configuration of the apparatus is given thereto.

This object is solved by a mixed drink producing apparatus, a household refrigeration apparatus and a method according to the independent claims.

A mixed drink producing apparatus according to the invention includes at least one dispensing container present for receiving a liquid addable to a mixed drink by the mixed drink producing apparatus. The dispensing container is connected to a dispensing unit of the mixed drink producing apparatus for conducting the liquid from the dispensing container to the dispensing unit. An essential idea of the invention is to be regarded in that the mixed drink producing apparatus has a gas adding unit, which is formed for adding carbonizing gas to the first liquid, in particular for addition outside of the dispensing container. The mixed drink producing apparatus moreover includes an inline mixer, by which the carbonizing gas added to the liquid can be processed, in particular disintegrated, in the state, in which it is already introduced into the liquid, and/or an inline carbonization, thus in particular an operation at least assisting the carbonization, is effected by the inline mixer itself on the path between the dispensing container and a dispensing unit of the mixed drink producing apparatus. By this configuration, a very compact construction is achieved since the inline mixer can also be disposed directly in the dispensing container itself. Moreover, the adjustment of the degree of carbonization is very fast and precisely allowed.

By the gas adding unit, the gas is first directly introduced into the liquid in particular by nozzles. The gas bubbles arising therein are preferably disintegrated by the inline mixer. Therein, sufficiently large boundary surfaces between the gas and the liquid are formed and the diffusion speeds are considerably increased. This reduces the required duration for carbonizing the liquid and moreover allows carbonizing during conveyance of the liquid to the dispensing unit. By the invention, additional storage tanks for an already carbonized liquid are omitted, which are present in the prior art in addition to the dispensing containers. In the invention, in this context, only the dispensing containers as such are therefore required and the carbonization is then effected already in this dispensing container itself. It can also be that a nozzle ensures sufficient boundary surfaces and further disintegration is omitted, wherein inline carbonization is effected here too.

In particular, it can be provided that the inline mixer is an active inline mixer. A stirrer driven by a motor can be provided as the active inline mixer.

However, it can also be provided that the inline mixer is a passive inline mixer. In such a configuration, it can for example be provided as a vortex generator. Vortex generators generate small-scale rotary movements in the flow, whereby significant intermixing is achieved.

In particular, a step-wise adjustment of the degree of carbonization of the liquid can also be effected by the gas input itself or by mixing non-carbonized liquids with carbonized liquids.

It can also be provided that the mixed drink producing apparatus has at least two separate inline mixers, which are connected in series with regard to the flow-through by the liquid charged with the carbonizing gas. In particular, it is provided that the number of the inline mixers, which are flown through in series with each other by the liquid, is formed depending on the desired degree of carbonization.

In particular, it is provided that the mixed drink producing apparatus has at least one further dispensing container, which is formed for receiving a further liquid addable to the mixed drink by the mixed drink producing apparatus and which is connected to the dispensing unit of the mixed drink producing apparatus for conducting the further or second liquid from the further dispensing container to the dispensing unit. By such a configuration, two different liquids, which in particular have different freezing points, can be stored and provided, which can then also be mixed to a mixed drink. One liquid can be water or contain water and the second liquid can be alcohol or contain alcohol.

In an advantageous implementation, it is provided that the mixed drink producing apparatus is also formed for receiving a capsule, in which an addition medium is contained. The addition medium can then also be added to the mixed drink.

Furthermore, the invention also relates to a household refrigeration apparatus for storing and preserving food, which can for example be a refrigerator or a freezer or a combined refrigerator-freezer. The household refrigeration apparatus has a receiving space for food. Moreover, the household refrigeration apparatus includes a mixed drink producing apparatus according to the invention or an advantageous configuration thereof.

Furthermore, the invention also relates to a method for producing a mixed drink by a household refrigeration apparatus, in particular by a mixed drink producing apparatus, which is formed with a first dispensing container, which is formed for receiving a liquid addable to the mixed drink by the mixed drink producing apparatus. The dispensing container is connected to a dispensing unit of the mixed drink producing apparatus for conducting the first liquid from the first dispensing container to the dispensing unit. An essential idea of the invention is to be regarded in that a carbonizing gas is added to the liquid by a gas adding unit of the mixed drink producing apparatus, in particular of the dispensing container, and the gas bubbles generated by introducing the carbonizing gas into the liquid are disintegrated by at least one inline mixer of the mixed drink producing apparatus.

The advantages achievable thereby with regard to fast and precise carbonization as well as a compact construction of the mixed drink producing apparatus are also accommodated thereby.

Advantageous implementations of the household refrigeration apparatus according to the invention are to be regarded as advantageous implementations of the method according to the invention, wherein the respective objective features of the mixed drink producing apparatus are thereto formed for performing the method steps.

In addition, it can also be provided that the mixed drink producing apparatus is formed for receiving a capsule, in which additives, which can be added to the mixed drink. Additives can be powdery or gelatinous or also liquid. In this context, the capsule can then be inserted into a dispensing area of the mixed drink producing apparatus and this ingredient of the capsule can then also be automatically dispensed or added or already be added upon dispensing the mixed drink.

In an advantageous implementation, it is provided that the mixed drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the mixed drink producing apparatus is accessible and exposed on the front side and not closed and covered by a door.

In an advantageous implementation, it is provided that the mixed drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the mixed drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of an embodiment of an overall container of the mixed drink producing apparatus.

### PREFERRED IMPLEMENTATIONS OF THE INVENTION

In the figures, identical or functionally identical elements are provided with the same reference characters.

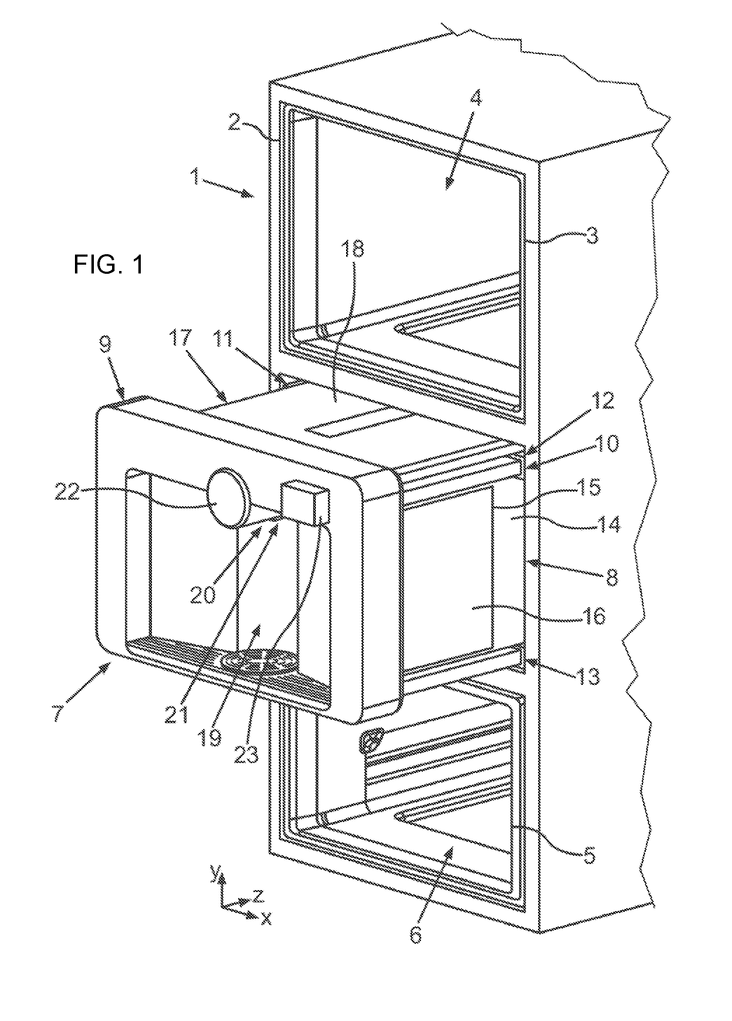

In FIG. 1, a household refrigeration apparatus 1 is illustrated in certain areas in a simplified perspective representation. Here, the household refrigeration apparatus 1 is for example a combined refrigerator-freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a mixed drink producing apparatus 7.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The mixed drink producing apparatus 7 is disposed accessible from the front side and thus from the front and the visible side. In particular, it is not closable and thus not coverable on the front side by a door.

The mixed drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the mixed drink producing apparatus 7 is advantageously displaceably supported in the interior container 8. Advantageously, the displacing device 10 also has an extraction stop, by which the drink apparatus formed in particular as a mixed drink producing apparatus 7 is secured in position in a completely extracted position shown in FIG. 1. Thus, over-extraction cannot be effected such that the mixed drink producing apparatus 7 cannot fall out to the front and tilt downwards, respectively.

Advantageously, it is also provided that the displacing device 10 has a displacing protection, by which the mixed drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead of it, a magnetic mount can also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead of it, it can also be provided that a corresponding access is formed at an opposing further vertical sidewall 17 and/or at least one such access 15 is formed at a ceiling wall 18 of the housing 9.

Moreover, the mixed drink producing apparatus 7 includes a recess or placing bay 19 on the front side, into which a drinking vessel can be placed, by which the mixed drink to be produced and dispensed by the mixed drink producing apparatus 7 can then be collected. The mixed drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can be admixed to this mixed drink to be produced, which can be produced and thus mixed from at least two different liquids. Thereto, it can in particular be provided that a capsule receptacle 22 is formed, into which a capsule having the mentioned additive or addition medium can be inserted. Upon dispensing the mixed drink, this ingredient or additive is then removed from the capsule and added to the mixed drink in particular before or after dispensing into the drinking vessel effected via the dispensing opening 21.

Moreover, it can in particular be provided that the mixed drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the mixed drink producing apparatus 7 has a cartridge for admixing carbon dioxide into the mixed drink. Thereto, the accessibility for cartridge exchange is allowed via at least one present access 15. In an advantageous implementation, it is provided that the mixed drink producing apparatus 7 is connected to a water connection external to household apparatus such that supply of water is for example allowed via a house water network. This has the additional advantage that a liquid to be added to the mixed drink as water does not have to be stored in a largely dimensioned container in the mixed drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the mixed drink producing apparatus 7, but additionally or instead thereof can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the mixed drink producing apparatus 7, or via a carbonized second liquid, which is then present in the second container.

It is in particular provided that the mixed drink producing apparatus 7 has a first container, in which a first liquid with a first freezing point, in particular water, is then provided or stored to then provide it for producing and dispensing a mixed drink depending on demand. Moreover, the mixed drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

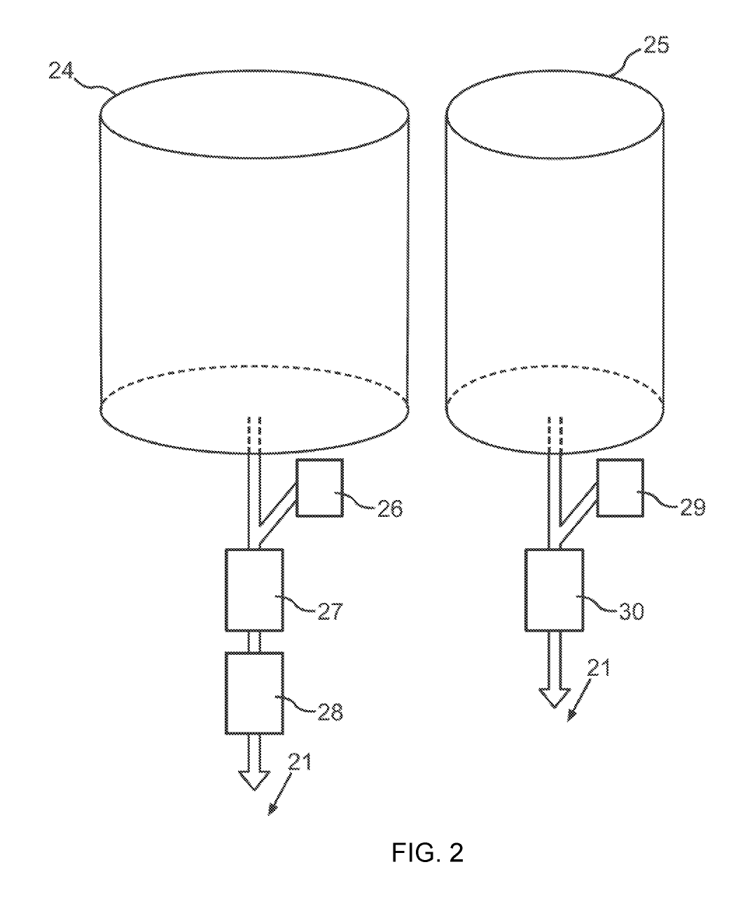

In FIG. 2, a dispensing container 24 of the mixed drink producing apparatus 7 is shown in a schematic representation. In an advantageous implementation, the mixed drink producing apparatus 7 includes a second dispensing container 25 separate therefrom, which is formed for receiving a further liquid. One of the liquids can be water or contain water and for example be received in the dispensing container 24. The further or second liquid can be alcohol or contain alcohol and be received in the further dispensing container 25.

In particular, it is provided that the liquid in the dispensing container 24 is carbonized on its conduction path from the dispensing unit 20 and thus to the dispensing opening 21 and thereto a carbonizing gas is first added to this liquid via a gas adding unit 26, in particular outside of the dispensing container 24 and in particular on the conduction path between the dispensing container 24 and the dispensing opening 21.

In the conduction path after addition of the carbonizing gas, a first inline mixer 27 is then disposed in the embodiment, through which this liquid charged with the carbonizing gas is conducted. In this first inline mixer 27, the gas bubbles generated in the liquid are disintegrated and the degree of carbonization is thereby individually adjusted. By disintegrating the gas bubbles, a sufficiently large boundary surface between the gas and the liquid is achieved and the diffusion speed is considerably increased. Thereby, considerable acceleration of the carbonization of the liquid is also achieved, and carbonization during conveyance of the liquid from the dispensing container 24 and the dispensing opening 21 and thus in particular inline carbonization is thus also achieved.

Moreover, it can also be provided that at least one second inline mixer 28 is disposed in series with the first inline mixer 27. It can also be provided that at least one bypass connection is formed between two inline mixers such that depending on through how many and/or through which inline mixers the liquid flows, different degrees of carbonization are adjustable in defined manner.

In addition or instead, it can also be provided that the liquid in the further dispensing container 25 is to be carbonized. Here too, as it is indicated in the simplified schematic representation in FIG. 2, a carbonizing gas can then be added to the liquid after exiting from the further dispensing container 25 on a conduction path between the further dispensing container 25 and the dispensing opening 21 by a further gas adding unit 29. Here too, it is then in particular provided that an inline mixer 30 is disposed on this conduction path, through which the liquid with the carbonizing gas is conducted such that disintegration of the gas bubbles in the liquid is then performed here too and the procedures and functionalities are analogous as they were explained to the inline mixers 27 and 28. Here too, at least one further inline mixer can be present in addition to the inline mixer 30, which is then also preferably connected in series therewith. With respect to the gas adding units 26 and 29, they can also be combined to a common gas adding unit. They can also be otherwise positioned.

Similarly, it can be provided that at least one inline mixer is formed for passing the liquid with the carbonizing gas from the dispensing container 24 as well as for passing the liquid with the carbonizing gas from the second dispensing container 25.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 dispensing container
25 dispensing container
26 gas adding unit
27 inline mixer
28 inline mixer
29 gas adding unit
30 inline mixer

1. A mixed drink producing apparatus, comprising:
a dispensing unit for dispensing liquid from the mixed drink producing apparatus,
a dispensing container, which is formed for receiving a liquid addable to a mixed drink by the mixed drink producing apparatus, wherein
the dispensing container is connected to the dispensing unit for conducting the liquid from the dispensing container to the dispensing unit,
a gas adding unit for adding carbonizing gas to the first liquid, and
at least one inline mixer, by which the carbonizing gas added to the liquid can be disintegrated and/or by which inline carbonization can be performed.

2. The mixed drink producing apparatus according to claim 1, wherein the inline mixer is an active inline mixer.

3. The mixed drink producing apparatus according to claim 2, wherein the active inline mixer is a stirrer driven by a motor.

4. The mixed drink producing apparatus according to claim 1, wherein the inline mixer is a passive inline mixer.

5. The mixed drink producing apparatus according to claim 4, wherein the passive inline mixer is a vortex generator.

6. The mixed drink producing apparatus according to claim 1, wherein the mixed drink producing apparatus has at least two inline mixers, which are connected in series with regard to flow-through of the liquid charged with the carbonizing gas.

7. The mixed drink producing apparatus according to claim 1, wherein the mixed drink producing apparatus has at least one further dispensing container, which is formed for receiving a second liquid addable to the cooled mixed drink by the mixed drink producing apparatus and which is connected to the dispensing unit of the mixed drink producing apparatus for conducting the second liquid from the dispensing container to the dispensing unit.

8. The mixed drink producing apparatus according to claim 7, wherein the two liquids have different freezing points.

9. The household refrigeration apparatus with a mixed drink producing apparatus, comprising:
a dispensing unit for dispensing liquid from the mixed drink producing apparatus,
a dispensing container, which is formed for receiving a liquid addable to a mixed drink by the mixed drink producing apparatus, wherein
the dispensing container is connected to the dispensing unit for conducting the liquid from the dispensing container to the dispensing unit,
a gas adding unit for adding carbonizing gas to the first liquid, and
at least one inline mixer, by which the carbonizing gas added to the liquid can be disintegrated and/or by which inline carbonization can be performed.

10. A method for producing a cooled mixed drink by a mixed drink producing apparatus, the method comprising the following steps of:
providing a dispensing unit for dispensing liquid from the mixed drink producing apparatus,
providing a dispensing container, which is formed for receiving a first liquid addable to a drink by the mixed drink producing apparatus,
connecting the dispensing container to the dispensing unit for conducting the liquid from the dispensing container to the dispensing unit,
adding a carbonizing gas to the first liquid by a gas adding unit of the mixed drink producing apparatus, wherein
the gas bubbles generated in the liquid by the introduction of the carbonizing gas are disintegrated by at least one inline mixer of the mixed drink producing apparatus and/or inline carbonization is performed.
